(19) United States
(12) Patent Application Publication
(10) Pub. No.: US 2019/0027959 A1
(43) Pub. Date: Jan. 24, 2019

(54) POWER SUPPLY APPARATUS

(71) Applicant: Lite-On Technology Corporation, Taipei (TW)

(72) Inventors: Yong-Long Lee, Taipei (TW); Wen-Che Tsai, Taipei (TW); Shih-Ming Chen, Taipei (TW)

(73) Assignee: Lite-On Technology Corporation, Taipei (TW)

(21) Appl. No.: 15/978,216

(22) Filed: May 14, 2018

Related U.S. Application Data
(60) Provisional application No. 62/535,959, filed on Jul. 23, 2017.

(30) Foreign Application Priority Data
Feb. 23, 2018 (CN) 201810155113.7

(51) Int. Cl. H02J 9/06

(52) U.S. Cl. CPC H02J 9/061; H02J 2009/068

(57) ABSTRACT

A power supply apparatus including a first rectifier switching circuit and a second rectifier switching circuit is provided. The first rectifier switching circuit is coupled between a live wire terminal and a neutral wire terminal of a first AC power and a first contact and a second contact. The second rectifier switching circuit is coupled between a live wire terminal and a neutral wire terminal of a second AC power and the first contact and the second contact. The first rectifier switching circuit performs rectification on the first AC power and thereby provides a rectified power to the first contact and the second contact when a status of the first AC power is normal. The second rectifier switching circuit performs rectification on the second AC power and thereby provides the rectified power to the first contact and the second contact when the status of the first AC power is abnormal.

### CROSS REFERENCE TO RELATED APPLICATION

This application claims the priority benefit of U.S. provisional application Ser. No. 62/535,959, filed on Jul. 23, 2017 and China application Ser. No. 201810155113.7, filed on Feb. 23, 2018. The entirety of each of the above-mentioned patent applications is hereby incorporated by reference herein and made a part of specification.

### BACKGROUND OF THE INVENTION

### Field of the Invention

The invention relates to a power supply technique, and particularly relates to a power supply apparatus with an automatic transfer switching (ATS) function.

### Description of Related Art

In order to ensure stable operation of an electronic system, a power supply apparatus with dual input power supply is generally adopted. The power supply apparatus with the dual input power supply generally has a function of Automatic Transfer Switch (ATS), which is adapted to automatically switch a standby input power to supply power to the electronic system when a main input power is abnormal, so as to avoid a problem of data loss or damage of the electronic system due to power supply interruption, and accordingly improve reliability of the electronic system.

Since the existing power supply apparatus with the dual input power supply has the ATS function, a circuit design thereof is more complex and hardware cost thereof is relatively high. Therefore, how to reduce the circuit complexity and the hardware cost of the power supply apparatus with the dual input power supply is one of the most important problems to be resolved by related technicians of the field.

### SUMMARY OF THE INVENTION

The invention is directed to a power supply apparatus, which not only has an Automatic Transfer Switch (ATS) function, but also has lower circuit complexity and hardware cost.

The invention provides a power supply apparatus including a first rectifier switching circuit and a second rectifier switching circuit. The first rectifier switching circuit is coupled to a first alternating current (AC) power. The first rectifier switching circuit includes a first solid state switch, a second solid state switch, a third solid state switch and a fourth solid state switch. A first terminal of the first solid state switch is coupled to a live wire terminal of the first AC power. A second terminal of the first solid state switch is coupled to a first contact. A first terminal of the second solid state switch is coupled to a second contact. A second terminal of the second solid state switch is coupled to the live wire terminal of the first AC power. A first terminal of the third solid state switch is coupled to a neutral wire terminal of the first AC power. A second terminal of the third solid state switch is coupled to the first contact. A first terminal of the fourth solid state switch is coupled to the second contact. A second terminal of the fourth solid state switch is coupled to the neutral wire terminal of the first AC power. The second rectifier switching circuit is coupled to a second AC power. The second rectifier switching circuit includes a fifth solid state switch, a sixth solid state switch, a seventh solid state switch and an eighth solid state switch. A first terminal of the fifth solid state switch is coupled to a live wire terminal of the second AC power. A second terminal of the fifth solid state switch is coupled to the first contact. A first terminal of the sixth solid state switch is coupled to the second contact. A second terminal of the sixth solid state switch is coupled to the live wire terminal of the second AC power. A first terminal of the seventh solid state switch is coupled to a neutral wire terminal of the second AC power. A second terminal of the seventh solid state switch is coupled to the first contact. A first terminal of the eighth solid state switch is coupled to the second contact. A second terminal of the eighth solid state switch is coupled to the neutral wire terminal of the second AC power. When a status of the first AC power is normal, the first solid state switch to the fourth solid state switch perform rectification on the first AC power in response to a first control signal, so as to provide a rectified power to the first contact and the second contact. When the status of the first AC power is abnormal, the fifth solid state switch to the eighth solid state switch perform rectification on the second AC power in response to a second control signal, so as to provide the rectified power to the first contact and the second contact.

According to the above description, in the power supply apparatus of the invention, the first rectifier switching circuit and the second rectifier switching circuit could be substantially regarded as Automatic Transfer Switches (ATS) with a rectifying function. Therefore, compared to the power supply apparatus adopting an independent ATS in collaboration with an independent rectifier circuit, the power supply apparatus of the invention has lower circuit complexity and lower hardware cost.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit schematic diagram of a power supply apparatus according to an embodiment of the invention.

FIG. 2 is a circuit schematic diagram of a power supply apparatus according to another embodiment of the invention.

FIG. 3 is a schematic diagram of an operation timing of the power supply apparatus of FIG. 2 according to an embodiment of the invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

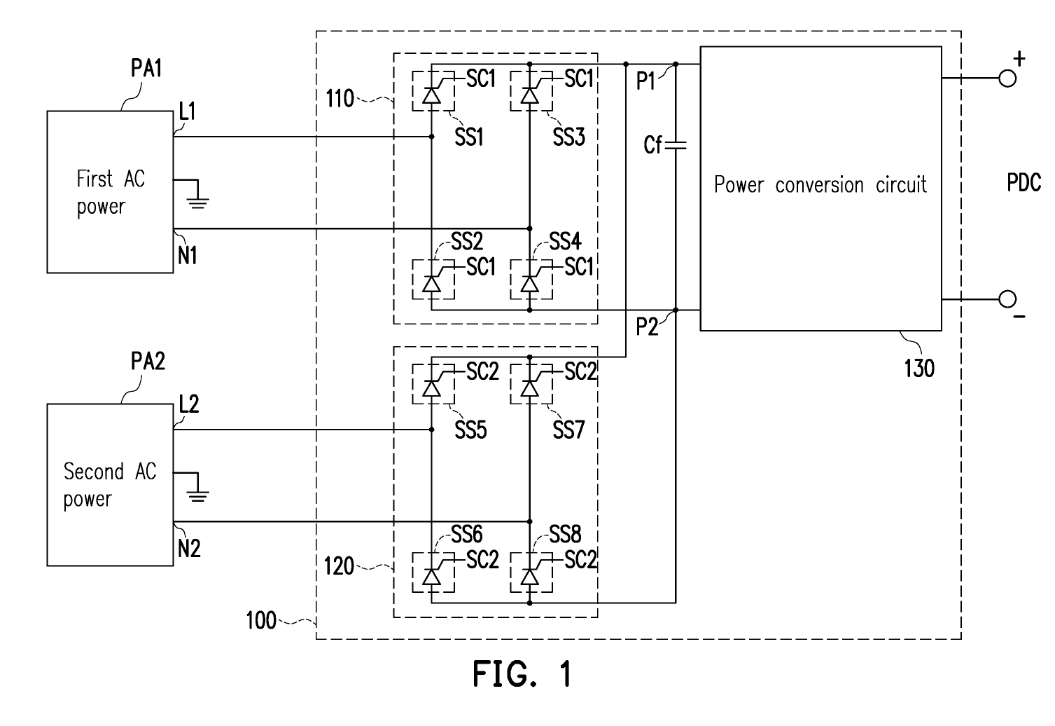

Referring to FIG. 1, FIG. 1 is a circuit schematic diagram of a power supply apparatus 100 according to an embodiment of the invention. As shown in FIG. 1, the power supply apparatus 100 may include a first rectifier switching circuit 110, a second rectifier switching circuit 120, and a power conversion circuit 130, though the invention is not limited thereto. In other embodiments of the invention, the power conversion circuit 130 may also be disposed outside the power supply apparatus 100 to form an independent power conversion apparatus, which is determined according to an actual application or design requirement.

The first rectifier switching circuit 110 is coupled to a first alternating current (AC) power PA1, and the second rectifier switching circuit 120 is coupled to a second AC power PA2. One of the first AC power PA1 and the second AC power PA2 may be taken as a main supply power, and the other one is taken as a standby supply power. However, to facilitate following description, the first AC power PA1 is taken as the main power supply of the powersupply apparatus 100, and the second AC power PA2 is taken as the standby supply power of the power supply apparatus 100 when the first AC power PA1 is abnormal (for example, power failure or a voltage is lower than a specific value). The implementation that takes the second AC power PA2 as the main supply power of the power supply apparatus 100 and takes the first AC power PA1 as the standby supply power of the power supply apparatus 100 may be deduced by analogy.

The first rectifier switching circuit 110 may include a first solid state switch SS1, a second solid state switch SS2, a third solid state switch SS3 and a fourth solid state switch SS4. A first terminal of the first solid state switch SS1 is coupled to a live wire terminal L1 of the first AC power PA1. A second terminal of the first solid state switch SS1 is coupled to a first contact P1. A first terminal of the second solid state switch SS2 is coupled to a second contact P2. A second terminal of the second solid state switch SS2 is coupled to the first terminal of the first solid state switch SS1, and is coupled to the live wire terminal L1 of the first AC power PA1. A first terminal of the third solid state switch SS3 is coupled to a neutral wire terminal N1 of the first AC power PA1. A second terminal of the third solid state switch SS3 is coupled to the first contact P1. A first terminal of the fourth solid state switch SS4 is coupled to the second contact P2. A second terminal of the fourth solid state switch SS4 is coupled to the first terminal of the third solid state switch SS3, and is coupled to the neutral wire terminal N1 of the first AC power PA1.

The second rectifier switching circuit 120 includes a fifth solid state switch SS5, a sixth solid state switch SS6, a seventh solid state switch SS7 and an eighth solid state switch SS8. A first terminal of the fifth solid state switch SS5 is coupled to a live wire terminal L2 of the second AC power PA2. A second terminal of the fifth solid state switch SS5 is coupled to the first contact P1. A first terminal of the sixth solid state switch SS6 is coupled to the second contact P2. A second terminal of the sixth solid state switch SS6 is coupled to the first terminal of the fifth solid state switch SS5, and is coupled to the live wire terminal L2 of the second AC power PA2. A first terminal of the seventh solid state switch SS7 is coupled to a neutral wire terminal N2 of the second AC power PA2. A second terminal of the seventh solid state switch SS7 is coupled to the first contact P1. A first terminal of the eighth solid state switch SS8 is coupled to the second contact P2. A second terminal of the eighth solid state switch SS8 is coupled to the first terminal of the seventh solid state switch SS7, and is coupled to the neutral wire terminal N2 of the second AC power PA2.

The power conversion circuit 130 is coupled to the first contact P1 and the second contact P2 to receive a rectified power, and converts the rectified power into a DC power PDC. In an embodiment of the invention, the power conversion circuit 130 may be any type of DC-to-DC converter, which may include a power factor correction circuit, a large capacitor and a boost or buck circuit, though the invention is not limited thereto.

Particularly, the first solid state switch SS1 to the fourth solid state switch SS4 perform rectification on the first AC power PA1 in response to a first control signal SC1 when a status of the first AC power PA1 is normal, so as to provide a rectified power to the first contact P1 and the second contact P2. The fifth solid state switch SS5 to the eighth solid state switch SS8 perform rectification on the second AC power PA2 in response to a second control signal SC2 when the status of the first AC power PA1 is abnormal, so as to provide a rectified power to the first contact P1 and the second contact P2.

Further, when the status of the first AC power PA1 is normal, the fifth solid state switch SS5 to the eighth solid state switch SS8 may be disabled through the second control signal SC2, and the first solid state switch SS1 to the fourth solid state switch SS4 are enabled through the first control signal SC1, such that the first solid state switch SS1 to the fourth solid state switch SS4 perform rectification on the first AC power PA1, and provide the rectified power to the first contact P1 and the second contact P2. Therefore, during a positive half cycle of the first AC power PA1, the live wire terminal L1 of the first AC power PA1, the first solid state SS1, the power conversion circuit 130, the fourth solid state switch SS4 and the neutral wire terminal N1 of the first AC power PA1 may form a current path; and during a negative half cycle of the first AC power PA1, the neutral wire terminal N1 of the first AC power PA1, the third solid state SS3, the power conversion circuit 130, the second solid state switch SS2 and the live wire terminal L1 of the first AC power PA1 may form another current path.

On the contrary, when the status of the first AC power PA1 is abnormal and the status of the second AC power PA2 is normal, the first solid state switch SS1 to the fourth solid state switch SS4 may be disabled through the first control signal SC1, and the fifth solid state switch SS5 to the eighth solid state switch SS8 are enabled through the second control signal SC2, such that the first solid state switch SS1 to the fourth solid state switch SS4 stop performing rectification on the first AC power PA1, and the fifth solid state switch SS5 to the eighth solid state switch SS8 perform rectification on the second AC power PA2, so as to provide the rectified power to the first contact P1 and the second contact P2. Therefore, during a positive half cycle of the second AC power PA2, the live wire terminal L2 of the second AC power PA2, the fifth solid state SS5, the power conversion circuit 130, the eighth solid state switch SS8 and the neutral wire terminal N2 of the second AC power PA2 may form a current path; and during a negative half cycle of the second AC power PA2, the neutral wire terminal N2 of the second AC power PA2, the seventh solid state SS7, the power conversion circuit 130, the sixth solid state switch SS6 and the live wire terminal L2 of the second AC power PA2 may form another current path.

Moreover, after the status of the first AC power PA1 is recovered from abnormal to normal, the fifth solid state switch SS5 to the eighth solid state switch SS8 may be disabled through the second control signal SC2, and the first solid state switch SS1 to the fourth solid state switch SS4 are enabled through the first control signal SC1, such that the first solid state switch SS1 to the fourth solid state switch SS4 perform rectification on the first AC power PA1, and provide the rectified power to the first contact P1 and the second contact P2.

It should be noted that the first rectifier switching circuit 110 and the second rectifier switching circuit 120 may be substantially regarded as Automatic Transfer Switches (ATS) having a rectifying function. Therefore, compared to the conventional power supply apparatus adopting the independent ATS in collaboration with the independent rectifier circuit, the power supply apparatus 100 of the present embodiment has lower circuit complexity. Besides, when the power supply apparatus 100 is activated and starts to receive the first AC power PA1, a time point of enabling the first solid state switch SS1 to the fourth solid state switch SS4 may be controlled through the first control signal SC1, so as to enable the first solid state switch SS1 to the fourth solid state switch SS4 when a voltage of the first AC power PA1 reaches a specific value, and accordingly suppress an inrush current of the power conversion circuit 130. In this way, the power conversion circuit 130 (or the power supply apparatus 100) may have no current limiter, such that overall hardware cost of the power supply apparatus 100 could be reduced.

In an embodiment of the invention, each of the first solid state switch SS1 to the eighth solid state switch SS8 may be a silicon controlled rectifier (SCR), though the invention is not limited thereto, where the first terminal of each of the first solid state switch SS1 to the eighth solid state switch SS8 is, for example, an anode terminal of the SCR, the second terminal of each of the first solid state switch SS1 to the eighth solid state switch SS8 is, for example, a cathode terminal of the SCR, a control terminal of each of the first solid state switch SS1 to the fourth solid state switch SS4 receives the first control signal SC1, and a control terminal of each of the fifth solid state switch SS5 to the eighth solid state switch SS8 receives the second control signal SC2.

In an embodiment of the invention, a filter capacitor Cf may be coupled in series between the first contact P1 and the second contact P2, so as to filter a high frequency noise in the rectified power, though the invention is not limited thereto.

In an embodiment of the invention, an Electromagnetic interference (EMI) filter may be disposed and coupled between the first rectifier switching circuit 110 of the power supply apparatus 100 and the first AC power PA1, so as to filter/suppress an EMI signal in the first AC power PA1. Similarly, an EMI filter may also be disposed and coupled between the second rectifier switching circuit 120 of the power supply apparatus 100 and the second AC power PA2, so as to filter/suppress an EMI signal in the second AC power PA2, though the invention is not limited thereto.

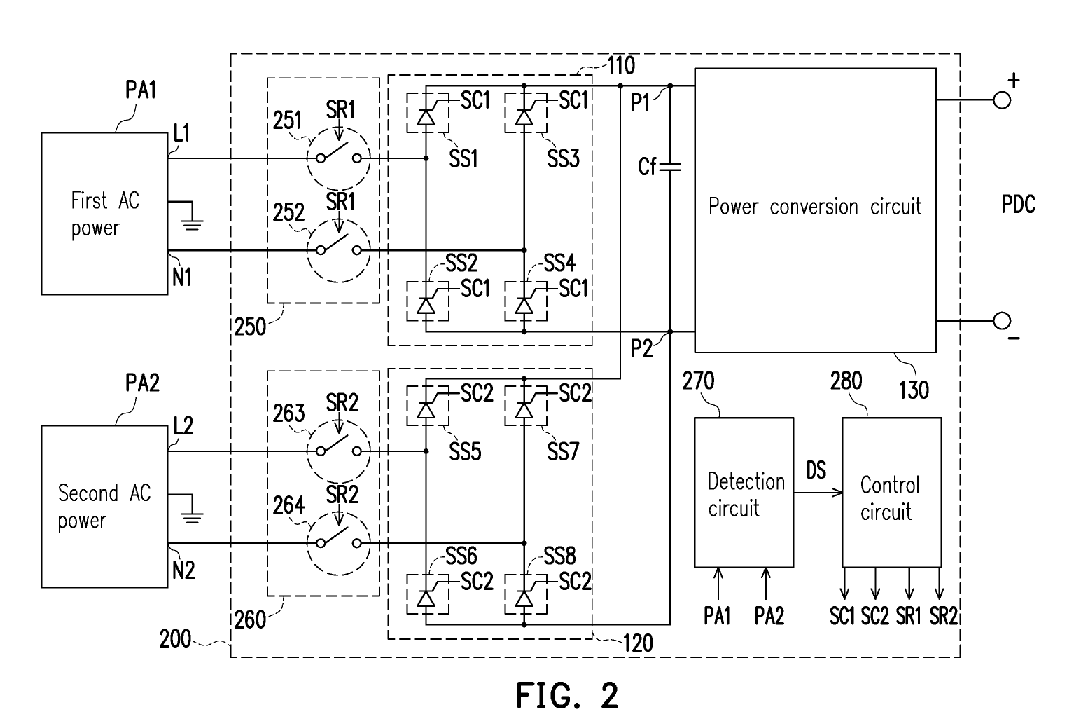

Referring to FIG. 2, FIG. 2 is a circuit schematic diagram of a power supply apparatus 200 according to another embodiment of the invention. As shown in FIG. 2, the power supply apparatus 200 may include the first rectifier switching circuit 110, the second rectifier switching circuit 120, the power conversion circuit 130, a first transmission switching circuit 250, a second transmission switching circuit 260, a detection circuit 270 and a control circuit 280, though the invention is not limited thereto. Implementation and operations of the first rectifier switching circuit 110, the second rectifier switching circuit 120 and the power conversion circuit 130 of the power supply apparatus 200 are respectively similar to that of the first rectifier switching circuit 110, the second rectifier switching circuit 120 and the power conversion circuit 130 of the power supply apparatus 100 of FIG. 1, and descriptions thereof may be deduced with reference of FIG. 1, which are not repeated.

The first transmission switching circuit 250 is coupled between the first AC power PA1 and the first rectifier switching circuit 110. The first transmission switching circuit 250 is controlled by a first switching signal SR1 to turn on or off the current path between the first AC power PA1 and the first rectifier switching circuit 110. The second transmission switching circuit 260 is coupled between the second AC power PA2 and the second rectifier switching circuit 120. The second transmission switching circuit 260 is controlled by a second switching signal SR2 to turn on or off the current path between the second AC power PA2 and the second rectifier switching circuit 120.

In an embodiment of the invention, the first transmission switching circuit 250 may include a first relay 251 and a second relay 252. The first relay 251 is coupled between the live wire terminal L1 of the first AC power PA1 and the first terminal of the first solid state switch SS1, and is controlled by the first switching signal SR1. The second relay 252 is coupled between the neutral wire terminal N1 of the first AC power PA1 and the first terminal of the third solid state switch SS3, and is controlled by the first switching signal SR1. Similarly, the second transmission switching circuit 260 may include a third relay 263 and a fourth relay 264. The third relay 263 is coupled between the live wire terminal L2 of the second AC power PA2 and the first terminal of the fifth solid state switch SS5, and is controlled by the second switching signal SR2. The fourth relay 264 is coupled between the neutral wire terminal N2 of the second AC power PA2 and the first terminal of the seventh solid state switch SS7, and is controlled by the second switching signal SR2.

In an embodiment of the invention, each one of the first relay 251, the second relay 252, the third relay 263 and the fourth relay 264 is, for example, an Electromagnetic Relay (EMR), though the invention is not limited thereto.

The detection circuit 270 is coupled to the first AC power PA1 and the second AC power PA2, and is configured to detect a status (for example, a voltage or a current) of the first AC power PA1 and the second AC power PA2 to obtain a detection signal DS. In an embodiment of the invention, the detection circuit 270 is, for example, a voltage sensor or a current sensor, though the invention is not limited thereto.

The control circuit 280 is coupled to the detection circuit 270, the first rectifier switching circuit 110, the second rectifier switching circuit 120, the first transmission switching circuit 250 and the second transmission switching circuit 260. The control circuit 280 may generate the first control signal SC1, the second control signal SC2, the first switching signal SR1 and the second switching signal SR2 according to the received detection signal DS.

In an embodiment of the invention, the control circuit 280 may be hardware, firmware, or software or machine executable program codes that are stored in a memory and executed by a microprocessor or a digital signal processor (DSP). In case of hardware implementation, the control circuit 280 may be implemented by a single integrated circuit chip, or implemented by a plurality of circuit chips, though the invention is not limited by the invention. The above multiple circuit chips or the single integrated circuit chip may be implemented by an application specific integrated circuit (ASIC), a programmable logic device (PLD) or a field programmable gate array (FPGA). The aforementioned memory may be a random access memory, a read-only memory or a flash memory, etc.

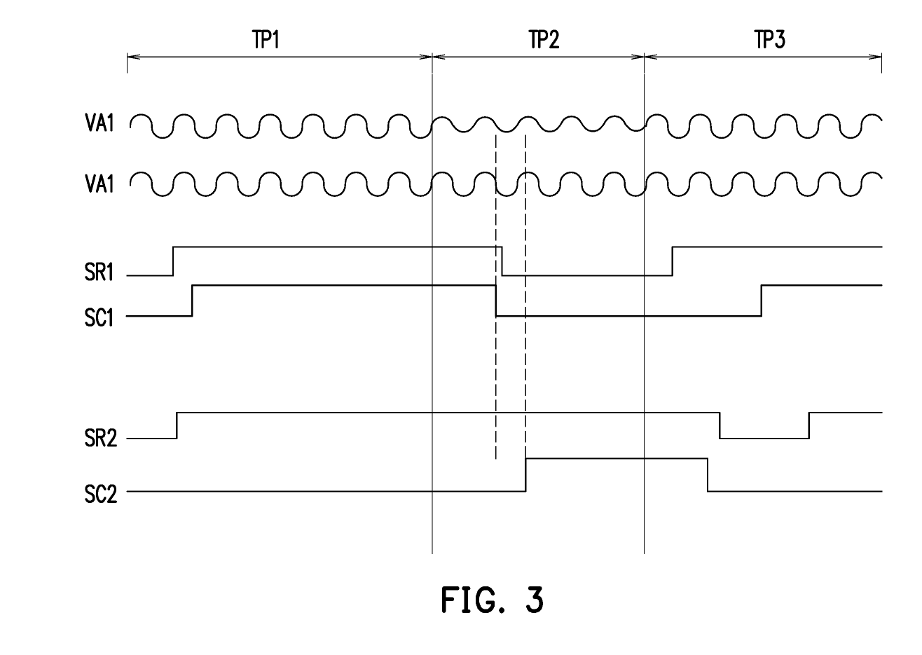

Referring to FIG. 2 and FIG. 3, FIG. 3 is a schematic diagram of an operation timing of the power supply apparatus 200 of FIG. 2 according to an embodiment of the invention. It should be noted that in the present embodiment a logic high level of each of the first control signal SC1, the second control signal SC2, the first switch signal SR1 and the second switch signal SR2 represents an enable state, and a logic low level of each of the first control signal SC1, the second control signal SC2, the first switch signal SR1 and the second switch signal SR2 represents a disable state. Namely, the first solid state switch SS1 to the fourth solid state switch SS4 (the fifth solid state switch SS5 to the eighth solid state switch SS8) are enabled in response to the first control signal SC1 (the second control signal SC2) that is at the logic high level, and the first solid state switch SS1 to the fourth solid state switch SS4 (the fifth solid state switch SS5 to the eighth solid state switch SS8) are disabled in response to the first control signal SC1 (the second control signal SC2) that is at the logic low level. Similarly, the first relay 251 and the second relay 252 (the third relay 263 and the fourth relay 264) are turned on in response to the first switching signal SR1 (the second switching signal SR2) that is at the logic high level, and the first relay 251 and the second relay 252 (the third relay 263 and the fourth relay 264) are turned off in response to the first switching signal SR1 (the second switching signal SR2) that is at the logic low level, though the invention is not limited thereto. Those skilled in the art should understand that a relationship between the logic high/low level of the first control signal SC1 (the second control signal SC2) and whether the first solid state switch SS1 to the fourth solid state switch SS4 (the fifth solid state switch SS5 to the eighth solid state switch SS8) are enabled/disabled may be defined by a designer according to an actual requirement. Similarly, a relationship between the logic high/low level of the first switching signal SR1 (the second switching signal SR2) and whether the first relay 251 and the second relay 252 (the third relay 263 and the fourth relay 264) are turned on/off may be defined by the designer according to an actual requirement.

First, in a time period TP1 shown in FIG. 3, the control circuit 280 determines the status of the first AC power PA1 to be normal (for example, a voltage VA1 of the first AC power PA1 is normal) according to the detection signal DS, and the control circuit 280 turns on the first transmission switching circuit 250 (since the first switching signal SR1 is switched to the logic high level), enables the first rectifier switching circuit 110 (since the first control single SC1 is switched to the logic high level), and disables the second rectifier switching circuit 120 (since the second control single SC2 is kept at the logic low level), such that the first solid state switch SS1 to the fourth solid state switch SS4 in the first rectifier switching circuit 110 perform rectification on the first AC power PA1, so as to provide the rectified power to the power conversion circuit 130. In other words, at this moment, the first AC power PA1 supplies power to the power conversion circuit 130.

It should be noted that since an EMR requires a longer time for being switched from a turn-off state to a stable turn-on state than that of an SCR, in the time period TP1 of FIG. 3, if the control circuit 280 determines the status of the second AC power PA2 to be normal (for example, a voltage VA2 of the second AC power PA2 is normal) according to the detection signal DS, the control circuit 280 may turn on the third relay 263 and the fourth relay 264 in the second transmission switching circuit 260 in advance (i.e. to switch the second switching signal SR2 to the logic high level) in case that the second rectifier switching circuit 120 is in the disable state. In this way, when the first AC power PA1 is abnormal, a speed that a power source of the power supply apparatus 200 is switched from the first AC power PA1 to the second AC power PA2 is accelerated.

Then, in a time period TP2 of FIG. 3, the second AC power PA2 is normal, and the first AC power PA1 is abnormal (for example, the voltage VA1 of the first AC power PA1 is in a brown-out state) and cannot normally supply power, the control circuit 280 may determine the status of the first AC power PA1 to be abnormal and the status of the second AC power PA2 to be normal according to the detection signal DS, and the control circuit 280 sequentially disables the first rectifier switching circuit 110 (switches the first control signal SC1 to the logic low level), turns off the first transmission switching circuit 250 (switches the first switching signal SR1 to the logic low level) and enables the second rectifier switching circuit 120 (switches the second control signal SC2 to the logic high level). Since the third relay 263 and the fourth relay 264 in the second transmission switching circuit 260 have been turned on in advance during the time period TP1, the fifth solid state switch SS5 to the eighth solid state switch SS8 may perform rectification on the second AC power PA2, and provide the rectified power to the power conversion circuit 130. At this moment, the first rectifier switching circuit 110 stops performing rectification on the first AC power PA1. In other words, the first AC power PA1 stops supplying power to the power conversion circuit 130, but the second AC power PA2 supplies power to the power conversion circuit 130.

Thereafter, in a time period TP3 of FIG. 3, the first AC power PA1 is recovered to normal from abnormal. Therefore, after the control circuit 280 determines that the first AC power PA1 is recovered from abnormal to normal according to the detection signal DS, the control circuit 280 sequentially turns on the first transmission switching circuit 250 (switches the first switching signal SR1 to the logic high level), disables the second rectifier switching circuit 120 (switches the second control signal SC2 to the logic low level), turns off the second transmission switching circuit 260 (switches the second switching signal SR2 to the logic low level), and enables the first rectifier switching circuit 110 (switches the first control signal SC1 to the logic high level), such that the second rectifier switching circuit 120 stops performing rectification on the second AC power PA2, and the first solid state switch SS1 to the fourth solid state switch SS4 of the first rectifier switching circuit 110 perform rectification on the first AC power PA1, and provide the rectified power to the power conversion circuit 130. In other words, at this moment, the second AC power PA2 stops supplying power to the power conversion circuit 130, but the first AC power PA1 supplies power to the power conversion circuit 130.

Moreover, in the time period TP3 of FIG. 3, the control circuit 280 may further turn on the second transmission switching circuit 260 after turning off the second transmission switching circuit 260 for a predetermined time length, so as to turn on the third relay 263 and the fourth relay 264 in the second transmission switching circuit 260 in advance (i.e. to switch the second switching signal SR2 to the logic high level) in case that the second rectifier switching circuit 120 is in the disable state. In this way, when the first AC power PA1 goes abnormal next time, the speed that the power source of the power supply apparatus 200 is switched from the first AC power PA1 to the second AC power PA2 is accelerated.

In summary, in the power supply apparatus of the invention, the first rectifier switching circuit and the second rectifier switching circuit could be substantially regarded as Automatic Transfer Switches (ATS) with a rectifying function. Therefore, compared to the power supply apparatus adopting an independent ATS in collaboration with an independent rectifier circuit, the power supply apparatus of the invention has lower circuit complexity. Besides, when the power supply apparatus is activated and starts to receive the first AC power, the first rectifier switching circuit may be enabled when the voltage of the first AC power reaches a specific value, so as to suppress an inrush current of the power conversion circuit. In this way, the power conversion circuit may have no current limiter, such that overall hardware cost of the power supply apparatus could be reduced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A power supply apparatus, comprising:
a first rectifier switching circuit, coupled to a first alternating current power, the first rectifier switching circuit comprising a first solid state switch, a second solid state switch, a third solid state switch and a fourth solid state switch, wherein a first terminal of the first solid state switch is coupled to a live wire terminal of the first alternating current power, a second terminal of the first solid state switch is coupled to a first contact, a first terminal of the second solid state switch is coupled to a second contact, a second terminal of the second solid state switch is coupled to the live wire terminal of the first alternating current power, a first terminal of the third solid state switch is coupled to a neutral wire terminal of the first alternating current power, a second terminal of the third solid state switch is coupled to the first contact, a first terminal of the fourth solid state switch is coupled to the second contact, and a second terminal of the fourth solid state switch is coupled to the neutral wire terminal of the first alternating current power; and
a second rectifier switching circuit, coupled to a second alternating current power, the second rectifier switching circuit comprising a fifth solid state switch, a sixth solid state switch, a seventh solid state switch and an eighth solid state switch, wherein a first terminal of the fifth solid state switch is coupled to a live wire terminal of the second alternating current power, a second terminal of the fifth solid state switch is coupled to the first contact, a first terminal of the sixth solid state switch is coupled to the second contact, a second terminal of the sixth solid state switch is coupled to the live wire terminal of the second alternating current power, a first terminal of the seventh solid state switch is coupled to a neutral wire terminal of the second alternating current power, a second terminal of the seventh solid state switch is coupled to the first contact, a first terminal of the eighth solid state switch is coupled to the second contact, and a second terminal of the eighth solid state switch is coupled to the neutral wire terminal of the second alternating current power,
wherein when a status of the first alternating current power is normal, the first solid state switch to the fourth solid state switch perform rectification on the first alternating current power in response to a first control signal, so as to provide a rectified power to the first contact and the second contact, and
when the status of the first alternating current power is abnormal, the fifth solid state switch to the eighth solid state switch perform rectification on the second alternating current power in response to a second control signal, so as to provide the rectified power to the first contact and the second contact.

2. The power supply apparatus as claimed in claim 1, wherein each of the first solid state switch to the eighth solid state switch is a silicon controlled rectifier, the first terminal of each of the first solid state switch to the eighth solid state switch is an anode terminal of the silicon controlled rectifier, and the second terminal of each of the first solid state switch to the eighth solid state switch is a cathode terminal of the silicon controlled rectifier.

3. The power supply apparatus as claimed in claim 1, further comprising:
a first transmission switching circuit, coupled between the first alternating current power and the first rectifier switching circuit, and controlled by a first switching signal to turn on or off a current path between the first alternating current power and the first rectifier switching circuit; and
a second transmission switching circuit, coupled between the second alternating current power and the second rectifier switching circuit, and controlled by a second switching signal to turn on or off a current path between the second alternating current power and the second rectifier switching circuit.

4. The power supply apparatus as claimed in claim 3,
wherein the first transmission switching circuit comprises:
a first relay, coupled between the live wire terminal of the first alternating current power and the first terminal of the first solid state switch, and controlled by the first switching signal; and
a second relay, coupled between the neutral wire terminal of the first alternating current power and the first terminal of the third solid state switch, and controlled by the first switching signal,
wherein the second transmission switching circuit comprises:
a third relay, coupled between the live wire terminal of the second alternating current power and the first terminal of the fifth solid state switch, and controlled by the second switching signal; and
a fourth relay, coupled between the neutral wire terminal of the second alternating current power and the first terminal of the seventh solid state switch, and controlled by the second switching signal.

5. The power supply apparatus as claimed in claim 3, further comprising:
a detection circuit, coupled to the first alternating current power and the second alternating current power, and configured to detect a status of the first alternating current power and a status of the second alternating current power to obtain a detection signal; and
a control circuit, coupled to the detection circuit, the first rectifier switching circuit, the second rectifier switching circuit, the first transmission switching circuit and the second transmission switching circuit, and configured to generate the first control signal, the second control signal, the first switching signal and the second switching signal according to the detection signal.

6. The power supply apparatus as claimed in claim 5, wherein
when the control circuit determines that the status of the first alternating current power is normal according to the detection signal, the control circuit turns on the first transmission switching circuit, enables the first rectifier switching circuit and disables the second rectifier switching circuit, such that the first solid state switch to the fourth solid state switch perform rectification on the first alternating current power to provide the rectified power; and
when the control circuit determines that the status of the second alternating current power is normal according to the detection signal, the control circuit turns on the second transmission switching circuit.

7. The power supply apparatus as claimed in claim 6, wherein
when the control circuit determines that the status of the first alternating current power is abnormal and the status of the second alternating current power is normal according to the detection signal, the control circuit disables the first rectifier switching circuit, turns off the first transmission switching circuit, enables the second rectifier switching circuit and maintains the second transmission switching circuit to a turn-on state, such that the fifth solid state switch to the eighth solid state switch perform rectification on the second alternating current power to provide the rectified power.

8. The power supply apparatus as claimed in claim 7, wherein
after the control circuit determines that the status of the first alternating current power is changed to normal from abnormal according to the detection signal, the control circuit sequential turns on the first transmission switching circuit, disables the second rectifier switching circuit, turns off the second transmission switching circuit, and enables the first rectifier switching circuit, such that the first solid state switch to the fourth solid state switch perform rectification on the first alternating current power to provide the rectified power.

9. The power supply apparatus as claimed in claim 8, wherein
after the control circuit determines that the status of the first alternating current power is changed to normal from abnormal according to the detection signal, the control circuit turns on the second transmission switching circuit after turning off the second transmission switching circuit for a predetermined time length.

10. The power supply apparatus as claimed in claim 1, further comprising:
a power conversion circuit, coupled to the first contact and the second contact to receive the rectified power, and converts the rectified power to generate a direct current power, wherein the power conversion circuit does not have a current limiter.
